(19) United States
(12) Patent Application Publication
(10) Pub. No.: US 2006/0260050 A1
(43) Pub. Date: Nov. 23, 2006

(54) Multi-table CT or MRI scanner arrangement for increasing patient throughput

(75) Inventor: James V. Manzione, Setauket, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: The Research Foundation of State University, New York, NY (US)

(21) Appl. No.: 11/347,196

(22) Filed: Feb. 3, 2006

Related U.S. Application Data
(60) Provisional application No. 60/651,337, filed on Feb. 9, 2005.

(51) Int. Cl. A61G 7/10

(52) U.S. Cl. 5/601; 5/81.1 R

(57) ABSTRACT

A medical imaging system with increased scan productivity or throughput. The invention allows hospitals and other medical facilities to ameliorate the high cost of imaging devices such as CT or MRI scanners while improving patient care and lowering per-patient costs. A single imaging device is arranged so that pre- or post-imaging processing of one or more patients and patient tables/tabletops can be performed simultaneously with imaging of another patient. The imaging device can be stationary, while patient tables/tabletops are movably guided by tracks on both sides of the imaging device. The imaging device can also be movable relative to the patient tables/tabletops. An overhead or floor track system can be used such as a circuit, or multiple track branches that merge at a junction. Or, the imaging device can be located at the center, or outside, of a carousel on which the patient tables are loaded and unloaded.

### CROSS REFERENCE TO RELATED APPLICATIONS

The present application claims benefit of U.S. Provisional Application No. 60/651,337 filed Feb. 9, 2005.

### BACKGROUND OF THE INVENTION

1. Field of Invention

The invention relates generally to a medical imaging system with increased patient throughput.

2. Description of Related Art

Conventional medical image devices such as computed tomography (CT) and magnetic resonance imaging (MRI) scanners have one scanner gantry and one patient table. Patient throughput is limited by the time it takes to place a patient on the patient table, prep the patient for the scan, perform the scan (scan time), take the patient off the table, and clean and prepare the table for the next patient. Scan time was prolonged on early scanners. However, on modern day scanners, scan time is significantly reduced. For example, a multislice CT scanner can perform a scan in the range of seconds to minutes. Scan time is therefore no longer a significantly limiting factor. What primarily limits productivity are pre and post scan procedures such as preparing the patient, placing the patient on the patient table, taking the patient off the patient table and preparing the scanner for the next patient.

### BRIEF SUMMARY OF THE INVENTION

The present invention addresses the above and other issues by providing a medical imaging system with increased scan productivity or throughput. The invention allows hospitals and other medical facilities to ameliorate the high cost of imaging devices such as CT or MRI scanners while improving patient care and lowering per-patient costs.

For example, one CT or MRI scanner with one gantry and two or more patient tables should increase productivity and revenue at less cost than acquiring two conventional CT or MRI scanners, each having one gantry and one table. Although the initial cost to set-up the medical imaging system can be higher than with conventional approaches due to increased floor space and construction requirements, the additional revenue generated by the increased throughput can rapidly justify the higher initial outlay.

Additionally, patient care is enhanced by providing faster patient access to the imaging device, and by maintaining the patient on one patient table throughout the imaging and pre- and post-processing.

In one aspect of the invention, a medical imaging system includes a medical imaging device, a first movable patient table/tabletop arranged on one side of the medical imaging device for moving a first patient toward, and away from, the medical imaging device, and a second movable patient table/tabletop arranged on an opposite side of the medical imaging device for moving a second patient toward, and away from, the medical imaging device. The medical imaging system can include a CT or MRI scanner, for instance. Furthermore, the first and second movable patient tables/tabletops can be guided by floor tracks or by overhead tracks. Folding shielded doors can be arranged on each side of the medical imaging device to contain any radiation emitted by the imaging device.

In another aspect, a medical imaging system includes a medical imaging device, a first patient table/tabletop arranged on one side of the medical imaging device, and a second patient table/tabletop arranged on an opposite side of the medical imaging device, where the medical imaging device is movable toward and away from the first patient table/tabletop, and toward and away from the second patient table/tabletop. The medical imaging device can be guided by floor tracks. Again, folding shielded doors can be arranged on each side of the medical imaging device.

In another aspect, a medical imaging system includes a medical imaging device, at least first and second patient tables/tabletops, and a track system for guiding movement of the first and second patient tables/tabletops, where the track system moves the first patient table/tabletop toward and away from the medical imaging device while the second patient table/tabletop is arranged in a processing area for pre- or post-scanning processing. Two or more patient tables/tabletops can be guided by the track system at the same time. The track system includes a loop for guiding the second patient table/tabletop from the processing area toward the medical imaging device for scanning of the associated patient while, at the same time, returning the first patient table/tabletop from an area in which the medical imaging device is located to the processing area. A folding shielded door can be arranged to separate the processing area from the area in which the medical imaging device is located. A mirror image of the above arrangement can also be used on an opposite side of the medical imaging device.

In another aspect, a medical imaging system includes a medical imaging device, at least first and second patient tables/tabletops, and a track system that includes at least a first branch and a second branch in respective processing areas that merge into a common track portion near the medical imaging device. The track system guides the first patient table/tabletop toward and away from the medical imaging device using the first branch and the common track portion, and also guides the second patient table/tabletop toward and away from the medical imaging device using the second branch and the common track portion. Additional branches and patient tables/tabletops that merge into the common track portion can also be provided. A folding shielded door can be arranged to separate the processing areas from the area in which the medical imaging device is located. A mirror image of the above arrangement can also be used on an opposite side of the medical imaging device.

In another aspect, a medical imaging system includes a medical imaging device, and a rotating carousel that carries at least one patient table/tabletop in a track, where the medical imaging device is located at a central region within the carousel. A patient can be processed at a processing area outside the carousel before the associated patient table/tabletop is guided by tracks onto the carousel when the carousel is stationary. The carousel is rotated until the patient table/tabletop reaches an access point to the medical imaging device. The patient table/tabletop is then guided radially inward by tracks to the central region for imaging. A folding shielded door can be arranged to separate the carousel from the area in which the medical imaging device is located. When the imaging is complete, the patient table/tabletop is guided radially outward, through the access point, back to the carousel. The carousel is rotated until the patient table/tabletop reaches the processing area, where the patient table/tabletop is guided radially outward and unloaded into the processing area. Additional processing areas can also be provided. A given patient can be loaded into the carousel at one processing station and unloaded at another, for example. Furthermore, a mirror image of the above arrangement can also be used, where an additional access point is provided on the other side of the medical imaging device. In this case, two patient tables/tabletops can be arranged in the central region at the same time, thereby allowing further increased patient throughput.

In another aspect, a medical imaging system includes a medical imaging device, and a rotating carousel that carries at least one patient table/tabletop in a track, where the medical imaging device is located radially outside the carousel. A patient can be processed at a processing area before the associated patient table/tabletop, guided by tracks, is loaded onto the carousel. The carousel is rotated until the patient table/tabletop reaches an access point to the medical imaging device. The patient table/tabletop is then guided radially outward by tracks to the medical imaging device for imaging. A folding shielded door can be arranged to separate the carousel from the area in which the medical imaging device is located. When the imaging is complete, the patient table/tabletop is guided radially inward, through the access point, back to the carousel. The carousel is rotated until the patient table/tabletop reaches the processing area, where the patient table/tabletop is guided radially outward and unloaded into the processing area. Additional processing areas can also be provided. As before, this provides the option for a given patient to be loaded into, and unloaded from, the carousel at different processing areas or stations.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a side view of a medical imaging system having a fixed medical imaging device and movable patient tables guided by floor tracks on each side of the medical imaging device;

FIG. 2a illustrates a side view of a medical imaging system having fixed patient tables on each side of a movable medical imaging device that is guided by floor tracks;

FIG. 2b illustrates an overhead view of the medical imaging system of FIG. 2a, where the medical imaging device is in an intermediate position;

FIG. 2c illustrates an overhead view of the medical imaging system of FIG. 2a, where the medical imaging device is in a position for imaging a first patient;

FIG. 2d illustrates an overhead view of the medical imaging system of FIG. 2a, where the medical imaging device is in a position for imaging a second patient;

FIG. 3 illustrates a side view of a medical imaging system having a fixed medical imaging device and movable patient tables guided by overhead tracks on each side of the medical imaging device;

FIG. 4 illustrates an overhead view of a medical imaging system having a fixed medical imaging device and movable patient tables guided by floor tracks, including a track circuit that forms a loop on each side of the medical imaging device;

FIG. 5 illustrates an overhead view of a medical imaging system having a fixed medical imaging device and movable patient tables guided by floor tracks, including separate branches that merge into a common track portion;

FIG. 6 illustrates an overhead view of a medical imaging system having a fixed centrally located medical imaging device, movable patient tables guided by floor tracks on a carousel, and processing areas; and

FIG. 7 illustrates an overhead view of a medical imaging system having a fixed radially outwardly located medical imaging device, movable patient tables guided by floor tracks on a carousel, and processing areas.

### DETAILED DESCRIPTION OF THE INVENTION

Conventional medical imaging devices such as CT and MRI scanners have one scanner gantry and one patient table, also referred to as a scanner table. In order to increase scanner productivity and patient throughput, a scanner gantry with two or more patient tables is proposed. The scan can be performed by moving the scanner gantry over the patient on the patient table, moving the patient table through the gantry, or some other arrangement linking the multiple patient tables to the scanner gantry. One CT/MRI scanner with one gantry and two or more tables should increase productivity and revenue at less cost than acquiring two conventional CT/MRI scanners, each having one gantry and one table. Various illustrative arrangements are provided below.

FIG. 1 illustrates a side view of a medical imaging system having a fixed medical imaging device and movable patient tables guided by floor tracks on each side of the medical imaging device. In this approach, a patient table is provided at each side of the medical imaging device, which can be an MRI or CT gantry, for instance. The patient table should be of a construction that is suitable for imaging. While one patient is being scanned on a first patient table, the second patient can be placed on the second patient table and prepared for scanning. Once the scan of the first patient on the first patient table is completed, the second patient can be scanned on the second patient table. While the patient on the second patient table is being scanned, a new, third patient can be prepared for scanning on the first patient table, and so forth.

Generally, the patients can be processed according to pre-imaging and post-imaging protocols. For example, pre-imaging protocols can include securing the patient on the patient table, administering a contrast agent, configuring the table based on the region of the body being scanned, e.g., configuring head or foot holders, and so forth. Post-imaging protocols can include removing the patient from the patient table, cleaning the patient table and surrounding area, and otherwise preparing the patient table for the next patient, e.g., by putting down new paper on the table and so forth.

Various control equipment that will be apparent to those skilled in the art can be provided as needed for controlling the medical imaging device and the movement of the patient tables. Additionally, video monitors can be provided for viewing the image data, and the work area can otherwise be configured as desired. It is also possible to incorporate other imaging devices into the system, such as angiography, fluoroscopy, nuclear imaging, and ultrasound.

In one possible approach, the patient tables are guided by respective drive mechanisms in the floor to move the patient tables toward, and away from, the medical imaging device. Various designs that will be apparent to those skilled in the art can be used. For example, an under floor belt that engages a base of the patient table can be driven by a drive wheel that is controlled by an automated control and/or by a human operator. A track such as a groove or opening in the floor can guide the movement of the patient tables. Another approach is for the patient table to be self-driven, e.g., using electric motors driving wheels of the base on which the patient table is carried. In this case, the patient tables can be guided by one or more tracks installed on the floor.

Generally, the track system used should provide a high positional accuracy when the patient table is guided into the imaging device so that accurate and repeatable positioning of the patient with respect to the imaging device can be achieved. Portions of the track system that are outside the area in which scanning is performed need not provide a significant positional accuracy and are meant to simply guided the patient tables to a desired general location such as a pre- or post-imaging processing area.

In any case, for imaging, the patient table is driven toward the imaging device until the patient is located at the desired position. The patient table can be moved incrementally as required during the scan as well. The patient table can include a cantilevered extension that is driven separately to position the patient within the imaging device. Typically, the portion of the patient that is being imaged is positioned within an aperture of the scanner.

Shielded folding doors can be used on each side of the imaging device to contain radiation that can be emitted during scanning. One folding door is closed on the side of the imaging device in which the patient who is not currently being imaged is located, while another folding door is open on the side of the imaging device in which the patient who is currently being imaged is located.

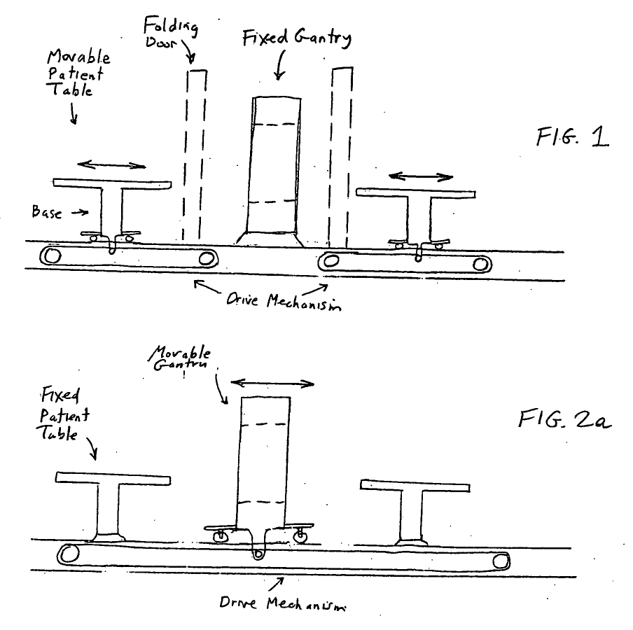

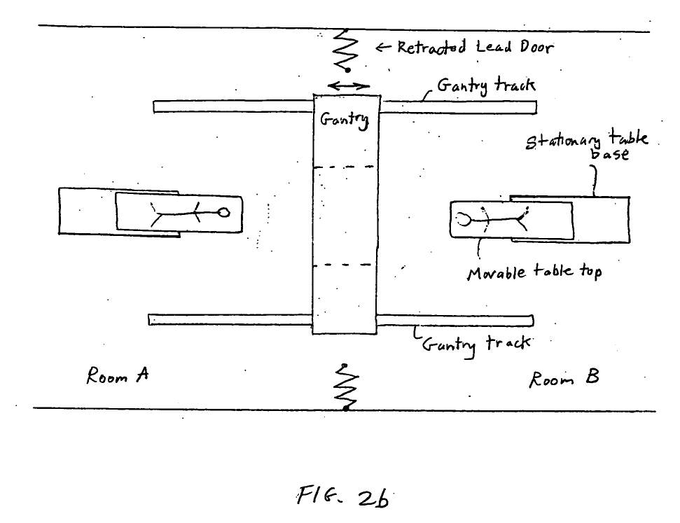

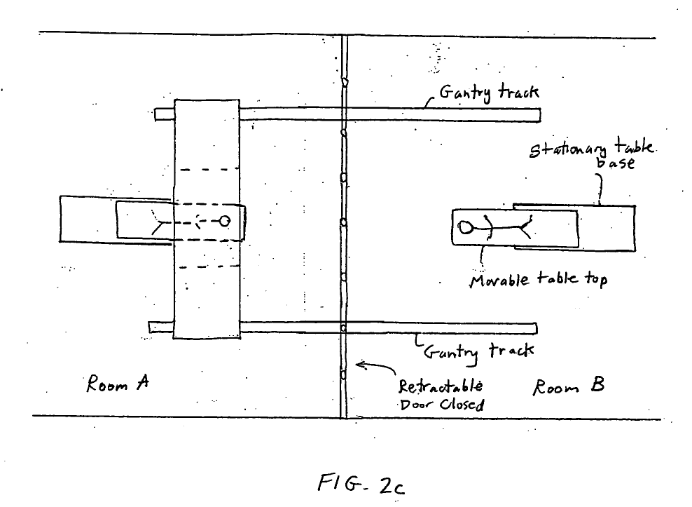

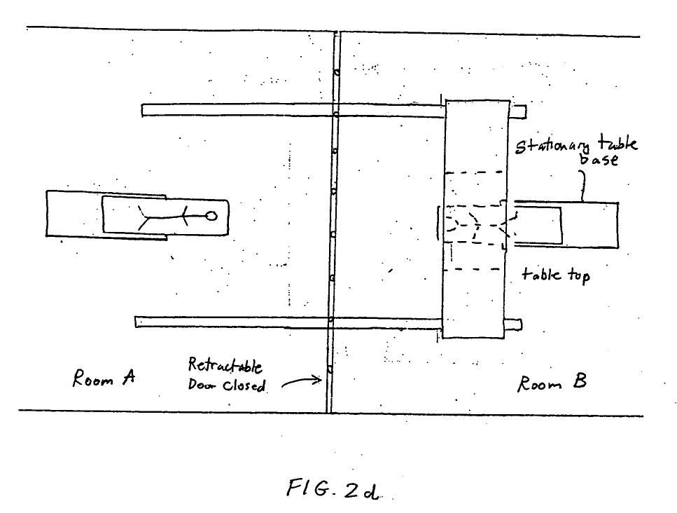

FIG. 2a illustrates a side view of a medical imaging system having fixed patient tables on each side of a movable medical imaging device that is guided by floor tracks. In this approach, the imaging device can be moved toward, and away from, either of the patient tables. In one possible approach, the imaging device is guided by a drive mechanism in the floor. Various designs that will be apparent to those skilled in the art can be used. As with the above-mentioned approaches, while one patient is being scanned on a first patient table, another patient can be positioned on the second patient table for pre- or post-scanning processing. Further details are provided below in connection with FIGS. 2b, 2c and 2d. Various control equipment that will be apparent to those skilled in the art can be provided as needed for controlling the medical imaging device and its movement.

FIG. 2b illustrates an overhead view of the medical imaging system of FIG. 2a, where the medical imaging device is in an intermediate position. The medical imaging device, which is a gantry in the present example, can be guided on tracks on each side of the device. A movable table top on which the patient is secured can be provided as a cantilevered extension of the stationary table base. The table and base arrangement can be duplicated on both sides of the gantry. A lead door is shown being in a retracted or folded position.

FIG. 2c illustrates an overhead view of the medical imaging system of FIG. 2a, where the medical imaging device is in a position for imaging a first patient. Here, the gantry is moved to an area referred to as “Room A” for imaging the associated patient. The patient is Room A is scanned while the patient in the opposite area referred to as Room B is prepared for scanning. The lead door is closed to shield Room B from radiation of the scanner.

FIG. 2d illustrates an overhead view of the medical imaging system of FIG. 2a, where the medical imaging device is in a position for imaging a second patient. Once, the scanning of the patient in Room A is completed, the lead door is opened, the gantry is moved to the position shown to scan the patient in Room B, and the lead door is closed again. The patient is Room B is scanned while a new patient in Room B is prepared for scanning. The process is repeated accordingly so that a pre-processed patient is always ready to be scanned.

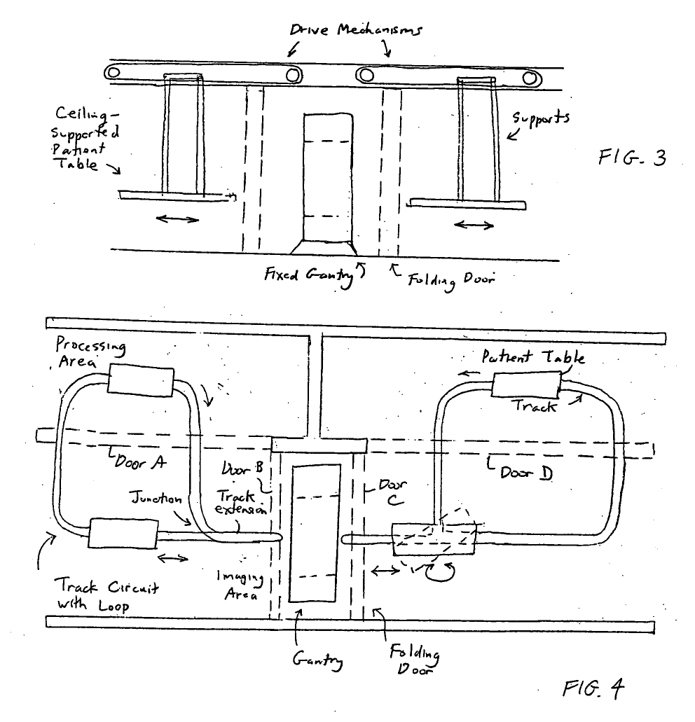

FIG. 3 illustrates a side view of a medical imaging system having a fixed medical imaging device and movable patient tables guided by overhead tracks on each side of the medical imaging device. This approach is analogous to the approach of FIG. 1 except the patient tables are carried by ceiling-mounted or other overhead tracks. Supports extend from the overhead tracks to the patient tables to support and move the patient tables. Respective drive mechanisms drive the patient tables toward, or away from, the imaging device.

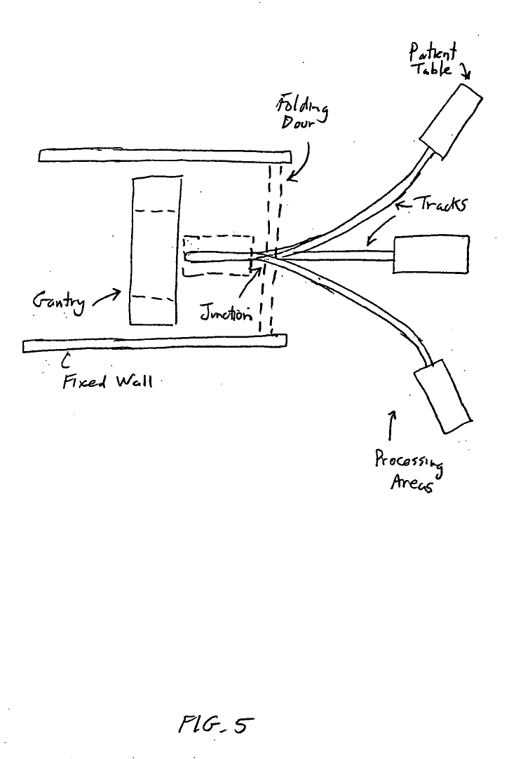

FIG. 4 illustrates an overhead view of a medical imaging system having a fixed medical imaging device and movable patient tables guided by floor tracks, including a track circuit that forms a loop on each side of the medical imaging device. A folding door (Door A) separates a processing area from an imaging area on one side of the imaging device. In the processing area, a first patient on a first patient table is processed according to either the pre- or post-imaging protocol. At the same time, a second patient on a second patient table can be positioned in the imaging area to be imaged by the imaging device, when Door B is open. At this time, Door C is closed to block radiation. When the second patient has been imaged, the second patient table is moved on the tracks, e.g., in a clockwise direction around the loop, to the processing area, while the first patient is moved to the imaging area and positioned for imaging by the imaging device. The system can be modified to accommodate additional patient tables in additional processing areas as well. Moreover, a mirror image arrangement can be provided on the other side of the imaging device as well. The imaging and processing of the patients on each side of the imaging device can be coordinated to optimize throughput.

Note that the track system includes a junction where a curved track portion meets a straight track portion, as shown at the left hand side of FIG. 4, or where straight track portions meet at a right angle, as shown at the right hand side of FIG. 4, for instance. When a patient table is transported from the processing area to the imaging area in the clockwise direction and reaches the curved track portion, the patient table is transferred to the straight track portion or extension near the imaging device. For a right angle junction, the patient table can be swiveled ninety degrees and transferred to the straight extension. Various mechanisms that will be apparent to those skilled in the art can be used to achieve such an operation.

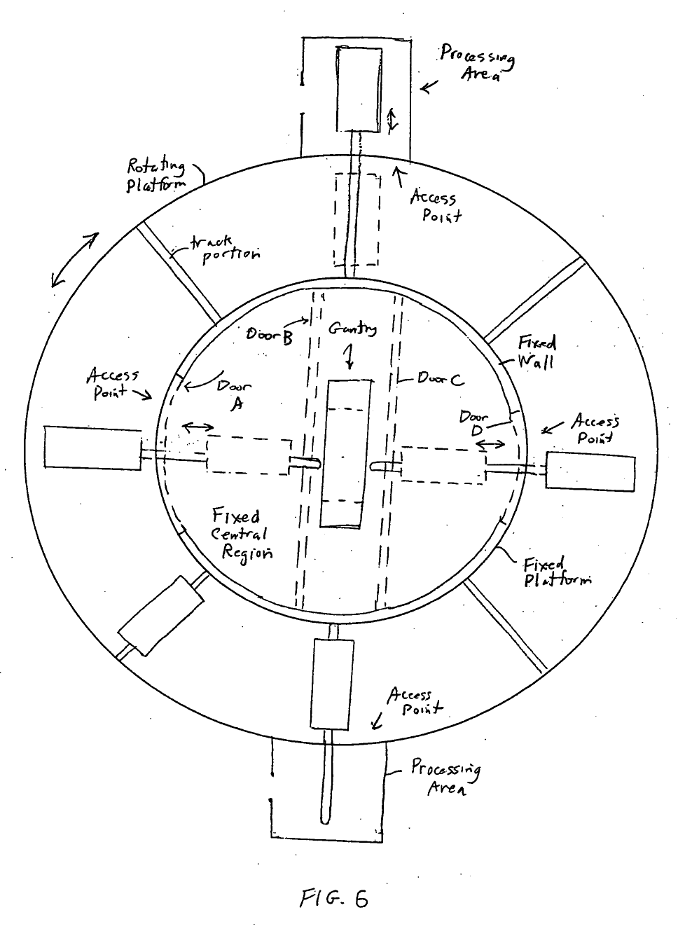

FIG. 5 illustrates an overhead view of a medical imaging system having a fixed medical imaging device and movable patient tables guided by floor tracks, including separate branches or spurs that merge into a common track portion. In this approach, each patient table is guided by a respective track branch that extends to a respective processing area. The different branches merge into a common track portion at a junction. Only one patient table at a time is moved to the imaging device, while pre- or post-processing can be performed on the other patients. When a first patient has been imaged, that patient is moved back to the respective processing area. The second patient is then moved to the imaging device. The folding door is closed when a patient is imaged to block radiation. A mirror image arrangement can be provided on the other side of the imaging device as well.

FIG. 6 illustrates an overhead view of a medical imaging system having a fixed centrally located medical imaging device, movable patient tables guided by floor tracks on a carousel, and processing areas. The imaging device can be provided in a fixed central region that can accommodate a patient table on each side of the imaging device. Track portions guided the movement of the patient tables. Surrounding the central region is a rotatable carousel having at least one track portion, and up to several track portions, which can extend radially. In one or more processing areas, patients are processed. After pre-imaging processing is completed, the patient table is moved to an available track portion on the carousel when the carousel is stationary. The carousel can be made stationary at a position at which a track portion in the processing area aligns with the available track portion on the carousel.

The patient table rotates on the carousel until the patient table is radially aligned with an access point to the central region. At this time, the patient table is moved radially inward to the central region, and a folding door, e.g., Door A, is closed behind the patient so that the patient can be imaged. Another folding door, e.g., Door B is opened and Door C is closed. Similarly, another patient can be positioned in the central region on the other side of the imaging device to be imaged. When the patient on the left side of the imaging device has been imaged, Door B can be closed and Door C opened so that the patient on the right side of the imaging device can be imaged.

While the patient on the right side of the imaging device is being imaged, the patient on the left side of the imaging device can be moved radially outward, back into the carousel, and the carousel can be rotated. As can be seen, great efficiencies can be achieved since multiple activities can be carried out at the same time. Essentially, each time the carousel stops, one or more patients can be moved onto, or off, the carousel, either to or from a processing area, and/or to or from the imaging area. Note that it is also possible for a patient to be processed while on the carousel itself.

In another option, the carousel is a partial arc of a circle that rotates less than 360 degrees. Due to the reduced rotation, this option can be most suitable when only one access point to the imaging device is available.

In yet another option, only one patient table at a time is accommodated in the central region, and the imaging device is located to one side of the central region rather than in the exact center. This approach allows the size, e.g., diameter, of the central region and, consequently, the carousel, to be reduced, thereby reducing costs and space requirements.

The carousel can be constructed as a rotating floor using design techniques that will be apparent to those skilled in the art. Advantageously, the cost for constructing the system is reduced since the imaging device remains stationary. The imaging device typically is very heavy and requires a stable, level platform to operate properly. In contrast, design tolerances are less strict for a carousel that only carries patient tables since the precise positioning of the patient tables on the carousel is not critical. However, it is possible for the imaging device to be located on the carousel, in which case the patient tables are inserted via radially inward or outward access points.

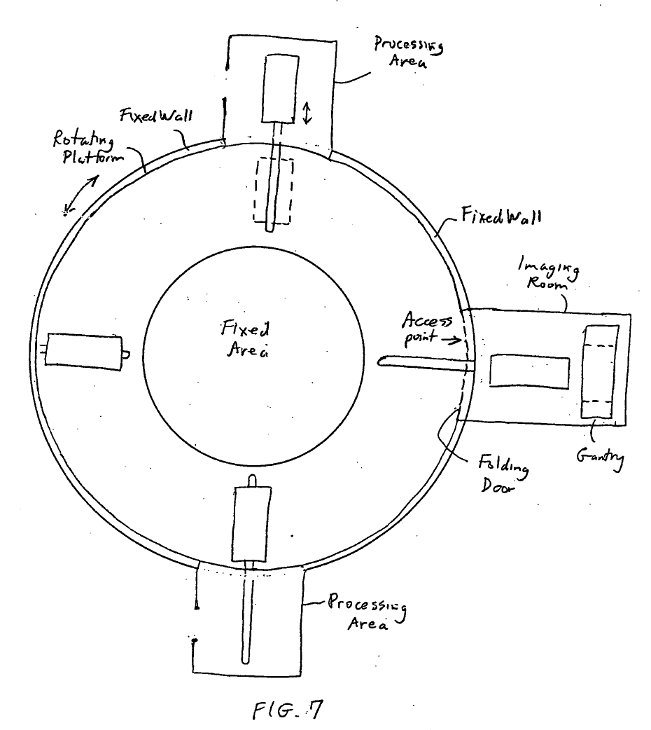

FIG. 7 illustrates an overhead view of a medical imaging system having a fixed radially outwardly located medical imaging device, movable patient tables guided by floor tracks on a carousel, and processing areas. This approach is analogous to that of FIG. 6 except the imaging device is located radially outward. As before, one or more processing areas can be provided for pre- and post-image processing. The patients are loaded onto the carousel and rotated until they reach the access point to an imaging room in which the imaging device is located. A designated patient can then be loaded into the imaging room while one or more other patients are loaded onto the carousel or unloaded from the carousel. Essentially, each time the carousel stops, one or more patients can be moved onto, or off, the carousel. In a further variation, the central region is used as a processing area for loading and unloading the patients into and from the imaging room.

Advantageously, in each case provided, pre- or post-processing can be performed on at least one patient while another patient is being imaged, thereby increasing patient throughput.

Note that while examples have been provided in which the medical imaging device includes an MRI or CT gantry, the invention is suitable for use with any medical imaging device, including open and stand up MRIs and other devices. For stand up devices, for example, the patent table can be arranged to pivot to place the patient in the desired orientation and position with respect to the imaging device.

Additionally, note that, in the embodiments discussed herein, overhead tracks can be used instead of, or in addition to, floor mounted tracks. Also, the scanner table base can be fixed while the patient is moved on a scanner tabletop, e.g., in the embodiments of FIGS. 3-7. Furthermore, the scanner or other imaging device can be movable on tracks as well, e.g. in the embodiments of FIGS. 4-7, so that the imaging device can moved toward and/or away from a patient table or tabletop. Typically, floor mounted tracks are practical in this case due to the substantial weight of most imaging devices.

Note that, in the embodiments of FIGS. 4-7, overhead tracks can be used instead of, or in addition to, floor mounted tracks.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention.

What is claimed is:

1. A medical imaging system, comprising:
a medical imaging device;
a first movable patient table/tabletop arranged on one side of the medical imaging device for moving a first patient toward, and away from, the medical imaging device; and
a second movable patient table/tabletop arranged on an opposite side of the medical imaging device for moving a second patient toward, and away from, the medical imaging device.

2. The medical imaging system of claim 1, further comprising:
folding shielded doors arranged on each side of the medical imaging device to contain radiation emitted by the medical imaging device.

3. The medical imaging system of claim 1, further comprising:
a track system for guiding movement of the first and second patient tables/tabletops.

4. The medical imaging system of claim 3, wherein:
the track system includes overhead tracks.

5. The medical imaging system of claim 3, wherein:
the track system includes floor mounted tracks.

6. The medical imaging system of claim 1, further comprising:
a rotating carousel that carries at least one of the patient tables/tabletops in a track.

7. The medical imaging system of claim 1, wherein:
the medical imaging device is movable toward and away from at least one of the first and second patient tables/tabletops.
